(19) United States
(12) Patent Application Publication
(10) Pub. No.: US 2015/0182991 A1
(43) Pub. Date: Jul. 2, 2015

(54) PROCESS FOR FORMING AN INTEGRAL FILM PRODUCT

(71) Applicant: JOHNSON & JOHNSON CONSUMER COMPANIES, INC., Skillman, NJ (US)

(72) Inventors: Curt Binner, Furlong, PA (US); Kenneth A. Pelley, Hopewell, NJ (US)

(21) Appl. No.: 14/580,974

(22) Filed: Dec. 23, 2014

Related U.S. Application Data
(60) Provisional application No. 61/922,287, filed on Dec. 31, 2013.

(51) Int. Cl. B05D 1/32; B05D 1/28

(52) U.S. Cl. CPC B05D 1/322; B05D 1/28

(57) ABSTRACT

A process, capable of commercial scale manufacturing of inexpensive, integral film product without the waste of die-cutting and which products are capable of use independent of a supporting structure on which they are formed, includes placing a mask over a substrate having a releasable surface, delivering a film-forming composition through the mask to form a raw shape on the substrate; removing the mask, and solidifying the raw shape into the integral film product disposed on the substrate. The mask has at least one aperture having a shape corresponding to the desired integral film product. The integral film product is arranged and configured to be removable from the releasable surface of the substrate for use independent of the substrate.

This application claims the benefit of U.S. provisional 61/922,287 filed on Dec. 31, 2013, the complete disclosure of which is hereby incorporated herein by reference for all purposes.

### BACKGROUND

Integral film products have a wide variety of uses. These include decorative window decals, plasters, adhesive bandages, and oral strips (both medicated and otherwise).

Conventional production of such integral film products generally involves die-cutting the desired shaped product from film stock. While this production produces inexpensive film stock, die-cutting limits the efficiency and/or variability of final product forming. If the product shape is not completely rectangular or otherwise completely tessellated, the surrounding ladder scrap can produce significant waste. Therefore, products that have costly raw materials are often restricted to square or other completely tessellated shapes to substantially eliminate this expensive waste. This unfortunately prevents the formation of optimal shapes for some uses. Examples of die-cutting medical films include such production techniques are described in Pharmedica Ltd., WO 2012104834 A1, Pinna et al, U.S. Pat. No. 7,612,048 B2, and Smithkline Beecham Corp., WO 2005/009386 A2.

On the other hand, printing—including stencil printing and screen printing—are known processes that are capable of providing irregular shapes on substrates. Generally, the printed materials remain on permanently joined to the substrates, such as printed text and graphics on paper, printed circuits in the electronics industry, and printed designs on clothing and signage. However, such integration of a carrying substrate into a printed element prevents the usage of the printed product separate from the substrate.

What is needed is a process capable of commercial scale manufacturing of inexpensive, integral film product without the waste of die-cutting and which products are capable of use independent of a supporting structure on which they are formed.

### SUMMARY

Surprisingly, we have found a process capable of commercial scale manufacturing of inexpensive, integral film product without the waste of die-cutting and which products are capable of use independent of a supporting structure on which they are formed. The process includes placing a mask over a substrate having a releasable surface, delivering a film-forming composition through the mask to form a raw shape on the substrate; removing the mask, and transforming the raw shape into the integral film product disposed on the substrate. The mask has at least one aperture having a shape corresponding to the desired integral film product. The integral film product is arranged and configured to be removable from the releasable surface of the substrate for use independent of the substrate.

In an alternative embodiment, a process for forming an integral film product includes placing a mask over a substrate having a releasable surface, delivering a film-forming composition through the mask to form a raw shape, removing the mask, and solidifying the raw shape into the integral film product disposed on the substrate. The film-forming composition and thus the integral film product includes a benefit agent, and the integral film product has a first surface arranged and configured to be removable from the releasable surface of the substrate for use independent of the substrate. The benefit agent is deliverable through the first surface of the integral film product.

### BRIEF DESCRIPTION OF THE DRAWING

FIG. 1 is a block diagram of a process according to one embodiment of the present invention.

FIG. 2 is a perspective view of a flatbed stencil printing system useful in one embodiment of the present invention.

FIG. 3 is a perspective view of a rotary stencil printing system useful in another embodiment of the present invention.

FIG. 4 is a side elevation of a flatbed screen printing system useful in another embodiment of the present invention.

FIG. 5 is a side elevation of a rotary screen printing system useful in yet another embodiment of the present invention.

FIGS. 6A-6D are cross-sections of the integral film products of the present invention.

FIGS. 7A-7E are a series of schematic side elevations of process steps showing the formation of an integral film product of the present invention.

FIG. 8 is a graph of stencil mask to finished product thickness.

FIG. 9 is a graph of screen mask to finished product thickness.

### DETAILED DESCRIPTION OF THE PREFERRED EMBODIMENTS

The present invention relates to a process and apparatus for forming integral film products. The following description is presented to enable one of ordinary skill in the art to make and use the invention. Various modifications to the embodiments and the generic principles and features described herein will be readily apparent to those skilled in the art. Thus, the present invention is not intended to be limited to the embodiments shown but is to be accorded the widest scope consistent with the principles and features described herein. Integral film products may have a wide variety of uses. These include household and recreational uses, such as decorative decals for windows and walls, temporary tattoos (such as body decals), healthcare devices such as medicated and/or absorbent plasters, adhesive bandages and other wound coverings, oral strips also known as a “consumable film” (medicated, therapeutic, and cosmetic), other body strips, such as moisturizing acne treatment, anti-wrinkle, dark circles, melisma, cellulite, delivery of vitamins, eczema, psoriasis, and the like.

As used herein the specification and the claims, the term “integral film product” variants thereof relate to a film product that is sufficiently robust to permit handling for a desired purpose separate from any supporting substrate. The product is removable from a substrate for use independent of the substrate.

As used herein the specification and the claims, the term “film-forming composition” variants thereof relate to a composition that is capable of forming, by itself or in the presence of an additional agent, a continuous film on a substrate.

As used herein the specification and the claims, the term “raw shape” variants thereof relate to the shaped volume of film-forming composition disposed on a substrate through an apertured mask. The raw shape generally requires further processing, such as integration, to transform it into an integral film product.

As used herein the specification and the claims, the term “solidification” variants thereof relate to the phase change from liquid to solid, can be through evaporation of a solvent, lowering of temperature, polymerization, cross-linking, and the like.

As used herein the specification and the claims, the term “tessellated” and variants thereof relate to a planar surface having a pattern of flat shapes having no overlaps or gaps. Thus, there is no “ladder waste between the shapes.

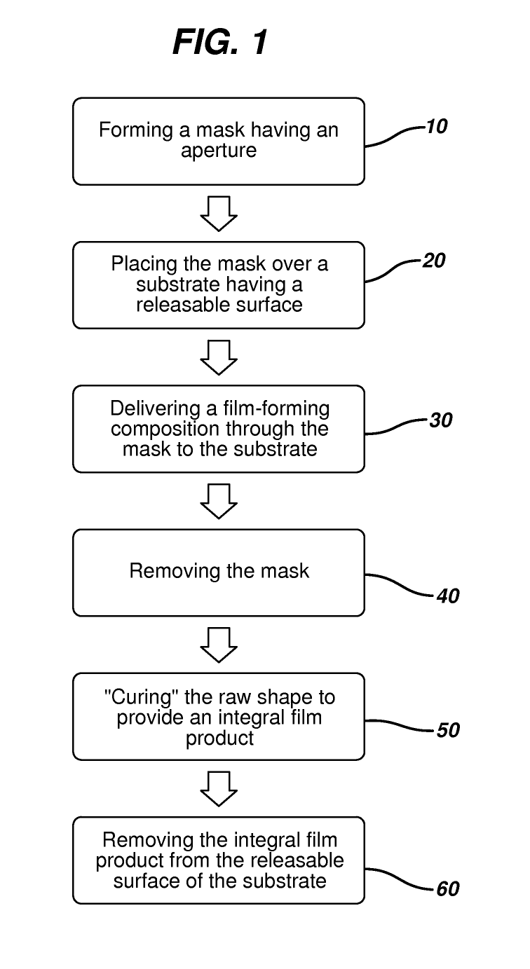

Referring to the drawing, FIG. 1 is a high level flow chart of a process for forming integral film products. A first Step 10 includes forming a mask having an aperture. A second Step 20 includes placing the mask over a substrate having a releasable surface a mask having an aperture. A third Step 30 includes delivering a film-forming composition through the mask to the substrate. A fourth Step 40 includes removing the mask. A fifth Step 50 includes solidifying the raw shape by transforming the film-forming material into the integral film product. A sixth Step 60 includes removing the integral film product from the releasable surface of the substrate. This can be done during the manufacture and packaging of the product, or it may be done by a consumer.

Step 10 involves forming a mask 102 having at least one aperture 104 corresponding to the desired integral film product (shown in FIG. 2, described below). The innovations of the present invention allow the shape to be as simple or complex as desired. In one advantage of the present invention, the shape can be relatively complex—the kind of shape that would produce excessive ladder waste in a die-cutting operation. For example, the minimum ladder waste produced during the printing of a pattern of nested circles is about 20% (based on circles arranged in straight columns and rows touching at the quadrants).

Print masks are known in the art. They can include without limitation stencils, screens, meshes, tapes, and the like. While the exact fabrication of the print mask is not critical to the present invention, our invention makes it possible to form relatively thick integral film products and therefore, use relatively thick masks. Preferably, the mask has a thickness of at least about 0.05 millimeters (“mm”). In one embodiment for use on the skin for flexible, relatively unnoticeable products, the mask has a thickness of between about 0.05 mm and about 0.3 mm, more preferably, between about 0.1 and about 0.2 mm. In another embodiment, thick integral film products can be made using a mask having a thickness of greater than about 0.2 mm, preferably between about 0.2 and about 2 mm, preferably between about 0.4 mm and about 1 mm, and most preferably between about 0.5 mm and about 1 mm. In many embodiments, the thickness of the mask is not critical, while in other embodiments, the present invention makes possible the formation of integral film products with previously unknown thicknesses.

The thickness of the mask generally determines the maximum thickness of the integral film product. The relationship is determined by the nature of the film-forming composition and the mechanism by which the composition solidifies. For example, hot melt and hydrocolloid film-forming compositions generally produce a product thickness that is essentially equivalent to the mask thickness. Foaming film-forming compositions can also be used and may provide solidified films having a thickness substantially equivalent to the thickness of the mask, or possibly even thicker. Solvent or other carrier-based compositions will lose thickness as the product solidifies. The reduction in thickness is generally related to the solids content of the composition. We have found that a solids content of 30-40% delivers an integral film product having a thickness of about 50% of the mask thickness. Formulations with lower solids content would likely deliver final products having a thickness of even less than 50% of the mask thickness.

For example, a stencil mask thickness of 0.5 mm would be capable of depositing a raw shape of film-forming composition of about 0.5 mm. Upon transformation into the integral film product, the thickness would diminish, based upon the solids content of the film-forming composition.

Different mesh sizes are used for different applications in the screen printing process. The mesh geometry will define the characteristics of the mesh. Screen mesh geometry is defined by the mesh count and thread (or wire or filament) diameter. The mesh count refers to the number of threads per inch contained in the mesh. The thread diameter refers to the diameter of the thread before it has been woven into the mesh. The thread diameter and mesh count together determine the mesh opening. Mesh opening is the spacing between the adjacent threads. Mesh opening size dictates the maximum particle size that can be used and affects the overall printed detail as well as the formula release characteristics. For optimum film-forming composition passage through the mesh the maximum particle size must be smaller than about ⅓ of the mesh opening.

Some typical mesh sizes and the pore openings associate with them are:

| Micron | U.S. Mesh |
|---|---|
| 2000 | 10 |
| 1000 | 18 |
| 500 | 35 |
| 250 | 60 |
| 149 | 100 |
| 125 | 120 |
| 105 | 140 |
| 74 | 200 |
| 53 | 270 |
| 37 | 400 |

The choice of materials is not critical in the production of the print masks of the present invention. Those of ordinary skill in the art will recognize that masks can be made of structural materials, including without limitation: metals, such as aluminum alloy, stainless steel, Ni alloy, Cr alloy or the like; resins, such mask as polyimide, polyester, epoxy, polycarbonate, polyethylene, polyethylene terephthalate (PET), polypropylene or the like; glass; paper; wood; or cardboard, as well as combination thereof. As another example, the mask body may be made of a composite material, such as glass fiber filled polyimides, polyesters, or epoxies. The mask body is formed in a sheet from these materials. The thickness of the sheet may be from 20 to 2000 microns (μm), although for ease in handling and other considerations, the thickness is preferably from 20 to 80 μm.

In a preferred embodiment, the mask has a uniform thickness. However, it is possible to employ a mask having a thickness that changes along the machine direction. For example, the mask may have a thickened central portion along the machine direction and tapered ends.

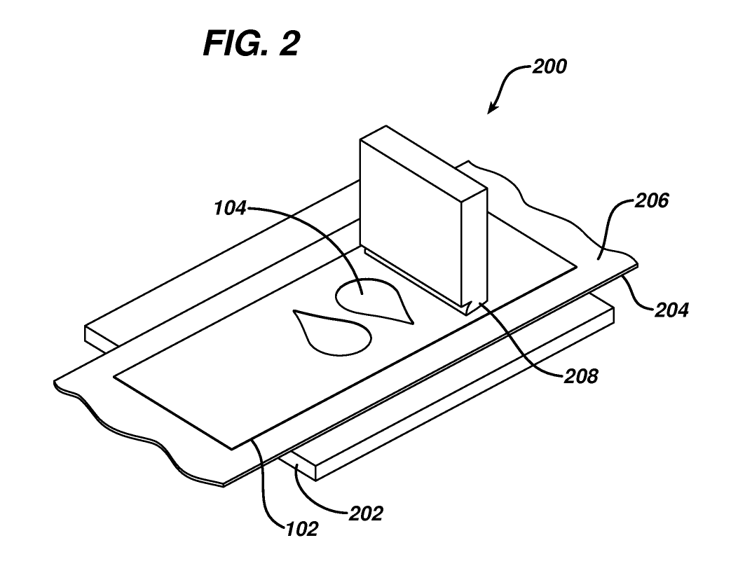

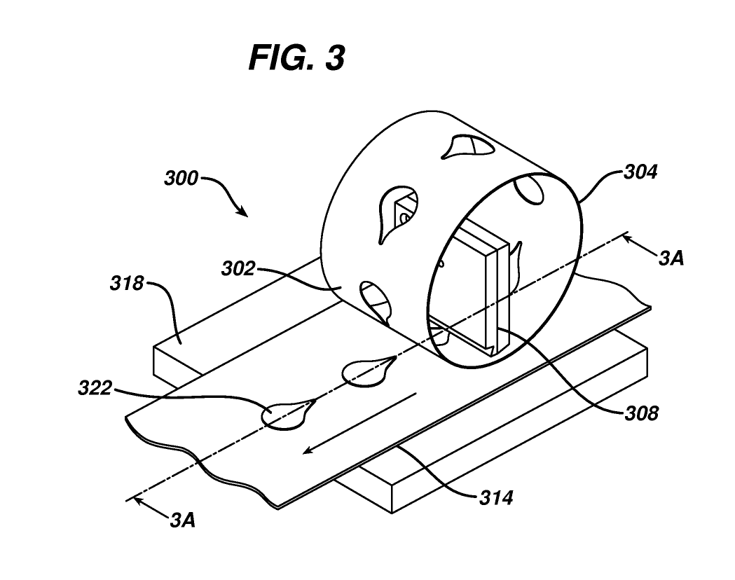

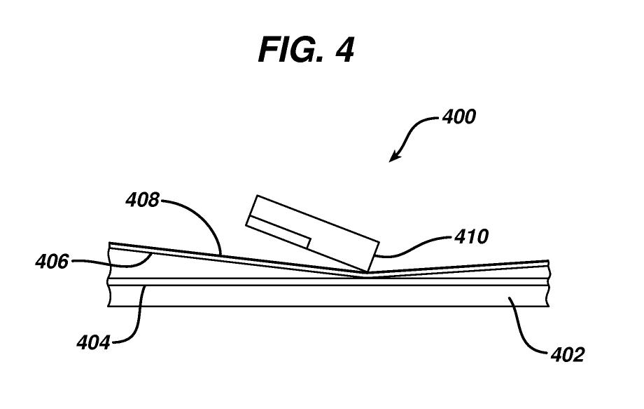

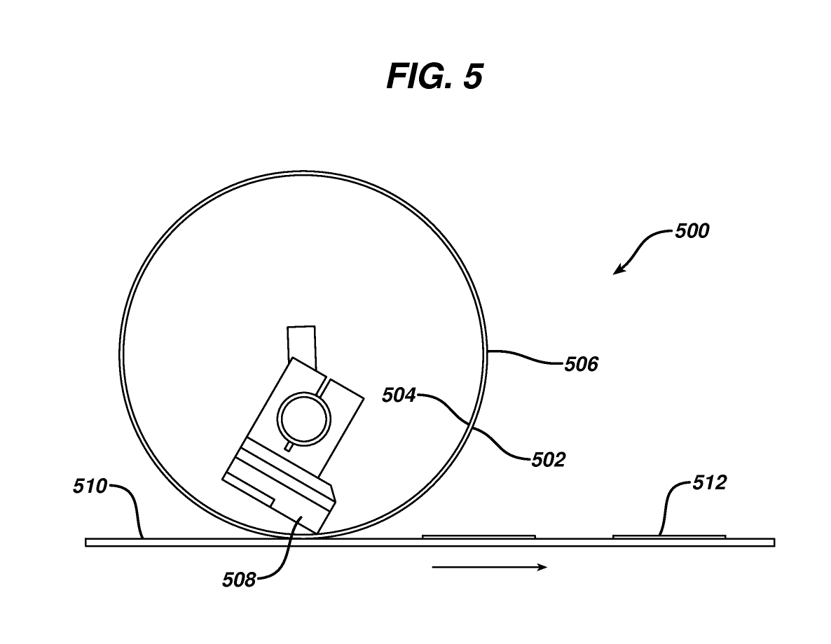

An example of a mask according to one embodiment of the present invention is a stencil shown in FIG. 2. This mask may be used in a flatbed stencil printing apparatus. In an alternative embodiment, shown in FIG. 3, the mask may be disposed on the surface of a drum in a rotary stencil printing apparatus. Additional variations include a flatbed screen printing mask (FIG. 4) and a rotary screen printing mask (FIG. 5).

In Step 20, the mask is placed over a substrate having a releasable surface. This releasable surface may be an endless belt (a continuous flexible web, linked platens, and the like), or it may be a web of release liner. Surfaces may be modified through the use of dry film lubricants such as molybdenum disulfide, graphite, tungsten disulfide or oils that are generally known to those of ordinary skill in the art. Typical release surfaces may include silicone, polytetrafluoroethylene (PTFE), waxes, polymers, polished metals, or combinations thereof. As shown above in FIGS. 2-5, the process may employ flatbed apparatus or rotary apparatus. The printing apparatus will have a support for a substrate, which substrate has a releasable surface, and system for delivering the film-forming composition through the mask (Step 30).

Delivery systems often include a conduit to provide the film-forming composition to the mask and a device to urge the composition to the mask aperture. Such devices include blade-like structures (also called knives, squeegees, doctor blades, wiper blades, wipers, and the like), nozzles and the like. The blade angle generally determines the relative force applied to move the composition into the mask aperture and to the substrate. The blade angle (the included angle defined by the blade and upper mask surface) will be optimized to work with the flow characteristics of the film-forming composition. Too small of an angle can starve the interface between blade and upper mask surface of film-forming composition, and too large of an angle will not provide sufficient pressure to deliver the composition into the mask aperture. In one embodiment of the invention, the blade angle is preferably less than about 45°, more preferably, between about 20° and 40°. A low blade angle, less than about 30°, works better for pushing more material in order to fill a thicker stencil. Pressurized nozzles can also be used which supply a material under constant pressure in order to fill the stencil.

In the embodiment of FIG. 2, a simple flatbed stencil system 200 is shown incorporating a flatbed support 202 for the substrate 204 having a releasable surface 206, a simple, flat stencil (mask 102), and a squeegee 208. In this process, the film-forming composition is deposited onto the mask/substrate assembly, and the squeegee wipes the film-forming composition across the mask aperture, filling the cavity defined by the mask and substrate. Excess film-forming composition is then removed from the vicinity of the mask aperture.

In the embodiment of FIG. 3 (including FIG. 3A), a more complex system 300 incorporates a stencil (mask 302) shown as the outer surface of a printing drum 304. The film-forming composition is delivered to the interior of the drum 304 via a conduit 306 and provided to a manifold 308. The manifold 308 has an open slot nozzle 310 arranged and configured to deliver the film-forming composition 312 through the mask 302 and to the substrate 314 as the aperture 316 of the mask 302 is supported by a substrate support 318. The manifold nozzle 310 then delivers and wipes the film-forming composition 312 across the mask aperture 316 as the mask 302 and substrate 314 are transported past the nozzle 310, filling the cavity defined by the mask aperture 316 and substrate 314. As the mask aperture 316 leaves the nozzle 310, the squeegee 320 wipes excess film-forming composition from the upper surface of the stencil (mask 302). The resulting raw shape 322 is then moved to the solidifying station (not shown) in which the raw shape is transformed into the integral film product.

In the embodiment of FIG. 4, the open stencil of FIG. 2 is replaced with a screen mask. Again, the system 400 includes a flatbed support 402 for the substrate 404, a simple; mask 406 formed on a screen 408, and a squeegee 410.

In this process, the film-forming composition is deposited onto the screen 408, and the squeegee 410 wipes the film-forming composition across the screen 408. The relative movement of the squeegee 410 with respect to the screen 408 forces the film-forming composition through the screen 408. The mask 406 associated with the screen 408 defines one or more apertures of a desired shape. Again, the thickness of the mask 406 generally defines the resulting integral film product thickness (accounting for some shrinkage during the solidifying Step 60, described below. The mask 406 comes into contact with the substrate 404 due to the squeegee pressure and forms a localized seal to the substrate to prevent escape of the film-forming composition from the desired shape. The screen 408 and releasable surface of the substrate 404 are selected to provide a greater surface affinity between the film-forming composition and the releasable substrate surface than between the film-forming composition and the screen.

Finally, FIG. 5 illustrates another more complex system 500 incorporates a mask 502 formed on a screen 504. The mask and screen combination are formed into a printing drum 506. The film-forming composition is delivered to the interior of the drum 506 via a conduit and delivered to the inner surface of the screen 504. A blade or squeegee 508 transfers the film-forming composition to the screen 504 and then to the substrate 510 as described above in relation to FIG. 4.

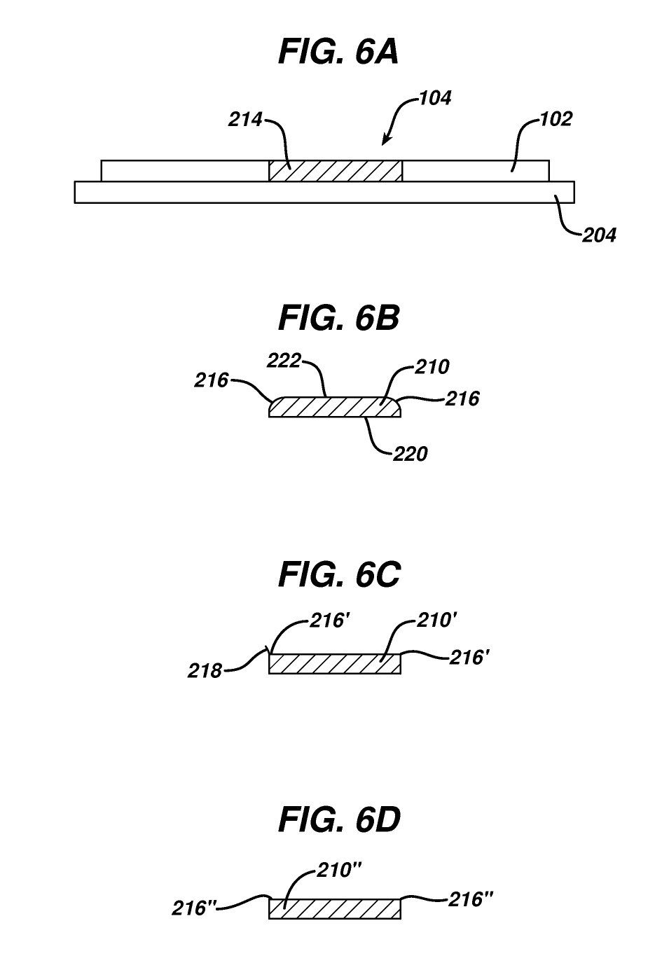

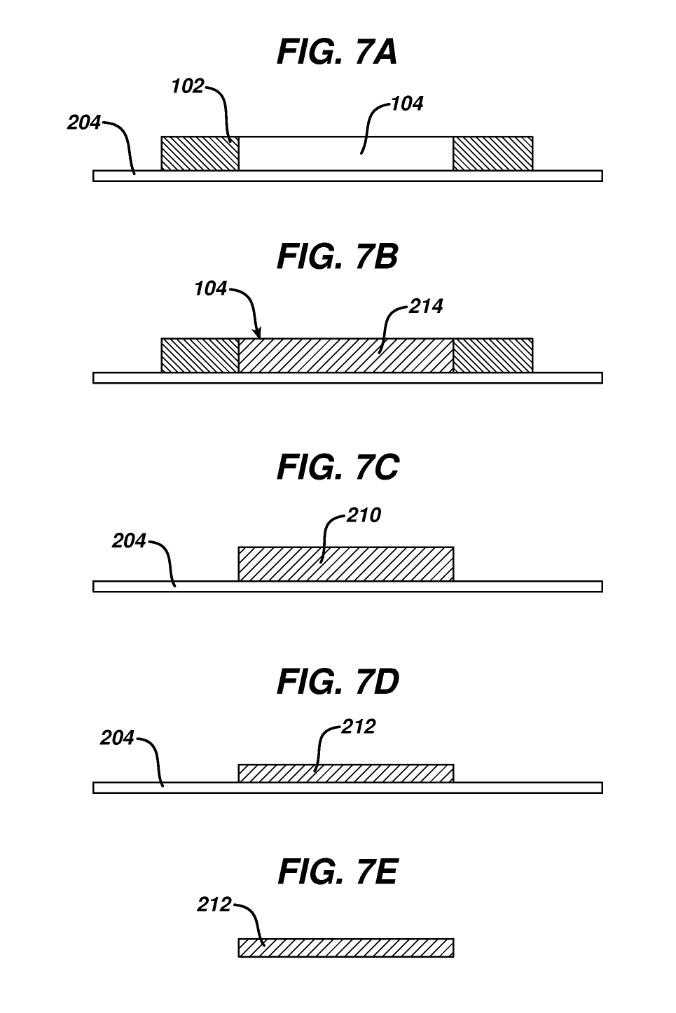

Step 40 involves removing the mask. In reference to the system of FIG. 2, once the squeegee 208 wipes the film-forming composition across the stencil (mask 102), the stencil (mask 102) is removed from the substrate 204 and the resulting raw shape 210 (shown in FIGS. 6 and 7) is then indexed to a solidifying station (not shown) in which the raw shape 210 is transformed into the integral film product 212 (shown in FIG. 7). As shown in FIG. 6A, the film-forming composition 214 fills the cavity defined by the mask aperture 104 and substrate 204 (described in FIG. 2). After the stencil (mask 102) is removed from the substrate 204, the raw shape 210 substantially maintains the form defined by the stencil (mask 102). However, it is within the scope of the invention that the boundaries of the raw shape 210 may change somewhat. For example, a the surface tension of a Newtonian fluid is likely to cause the upper edges 216 of the raw shape 210 to soften from a right angle to a curved edge as shown in FIG. 6B after removal of the constraining stencil (mask 102). On the other hand as shown in FIG. 6C, the upper edges 216′ of a non-Newtonian composition may be stiffer and may be disturbed during the removal of the constraining stencil (mask 102). Thus, “flashing” 218 may extend from the upper edges as some of the raw shape 210′ may drag with the stencil (mask 102) as it is removed from the substrate. Alternately, the upper edges 216″ may form a nearly square angle with respect to the sides of the raw shape 210″ (FIG. 6D).

In a rotary process (as shown for example in FIG. 5) the as the substrate 510 travels away from the printing drum 506, the raw shape 512 is exposed as the mask 502 on the surface of the printing drum 506 rotates out of the plane of the substrate 510. Again, the raw shape 512 travels to a solidifying station (not shown) at which the raw shape 512 transforms into the integral film product that is removable from the releasable surface of the substrate for use independent of the substrate. The rotary process also provides rapid removal of the mask from the raw shape. This can improve the print quality as there is less opportunity for the film-forming composition to wick between the mask and the substrate.

In Step 60, the integral film product is removed from the releasable surface of the substrate for use independent of the substrate. If the process according to the present invention employs a release lined web as the substrate, the release lined web may be used as a carrier and packaged with the integral film product in appropriate sized primary packaging until delivered to a consumer. The consumer may then remove the integral film product from the substrate and use it as desired. Alternately, if the process according to the present invention employs an endless belt having a releasable surface or other substrate integrated into the manufacturing equipment, the integral film product is removed from the releasable surface of the substrate and packaged for delivery to a consumer. The integral film product may have an adhesive surface, such as in a medicated plaster, or it may have non-tacky surfaces, such as in an oral strip.

To summarize the process, generally described above, FIGS. 7A-7E shows elements of the process in cross-section. In step 20, a mask 102 having an aperture 104 is placed over a substrate 204 (FIG. 7A). In step 30, the mask aperture 104 is filled with film-forming composition 214 (FIG. 7B), and the mask 102 is removed in step 40, leaving a raw shape 210 on the substrate 204 (FIG. 7C). In step 50 (FIG. 7D) the raw shape 210 is solidified to form the integral film product 212 (shown as having a reduced thickness due to the removal of a solvent, such as water). Finally, the integral film product 212 is removed from the substrate 204 (FIG. 7E).

The film-forming compositions employed in the present invention may be in the form of a hotmelt composition, a solid material that can be melted to form a flowable liquid and deposited to form a raw shape which can then cool to form the integral film product. Alternatively, the film-forming composition may include at least a film forming component and a carrier. Additional components may include, without limitation, emulsifiers, surfactants, plasticizers, active ingredients, fragrances, coloring agents, flavorings, and other components known to those of ordinary skill in the art. The carrier is preferably a liquid and may be a solvent or diluent. Preferred carriers include water and alcohols.

The water soluble polymers of the present invention possess film forming properties useful producing the films of the present invention. Many water soluble polymers may be used in the films of the present invention. A representative, non-limiting list includes pullulan, cellulose ethers (such as hydroxypropylmethyl cellulose, hydroxyethyl cellulose, hydroxypropyl cellulose), polyvinyl pyrrolidone, carboxymethyl cellulose, polyvinyl alcohol, sodium alginate, polyethylene glycol, tragacanth gum, guar gum, acacia gum, arabic gum, polyacrylic acid, methylmethacrylate copolymers, carboxyvinyl polymers, amylose, starches (such as high amylose starch and hydroxypropylated high amylose starch), dextrin, pectin, chitin, chitosan, levan, elsinan, collagen, gelatin, zein, gluten, soy protein isolate, whey protein isolate, casein and/or mixtures thereof.

In one preferred embodiment, the carrier is water. In alternate embodiments, organic solvents which have been conventionally used can be employed as the solvent. A representative, non-limiting list of useful solvents includes monovalent alcohols such as methanol, ethanol, propanol, butanol, 3-methoxy-3-methyl-1-butanol, and 3-methoxy-1-butanol; alkylcarboxylic acid esters such as methyl-3-methoxypropionate, and ethyl-3-ethoxypropionate; polyhydric alcohols such as ethylene glycol, diethylene glycol, and propylene glycol; polyhydric alcohol derivatives such as ethylene glycol monomethyl ether, ethylene glycol monoethyl ether, ethylene glycol monopropyl ether, ethylene glycol monobutyl ether, propylene glycol monomethyl ether, propylene glycol monoethyl ether, propylene glycol monopropyl ether, propylene glycol monobutyl ether, ethylene glycol monomethyl ether acetate, ethylene glycol monoethyl ether acetate, and propylene glycol monomethyl ether acetate; fatty acids such as acetic acid, and propionic acid; ketone such as acetone, methyl ethyl ketone, and 2-heptanone. These organic solvents may be used alone, or in combination.

The film product may also contain at least one surfactant, including anionic, amphoteric, non-ionic, and cationic surfactants or mixtures thereof.

A representative, non-limiting list of anionic surfactants includes, alone or mixed, salts (for example salts of alkali metals, such as of sodium, ammonium salts, salts of amines, salts of amino-alcohols or magnesium salts) of the following compounds: alkyl sulphates, alkylether sulphates, alkylamidoether-sulphates, alkylarylpolyether-sulphates, monoglyceride sulphates, alkyl sulphonates, alkyl phosphates, alkylamide sulphonates, alkaryl sulphonates, alpha-olefin sulphonates, paraffin sulphonates; alkyl sulphosuccinates, alkylether sulphosuccinates, alkylamide-sulphosuccinates, alkyl sulphosuccinamates, alkyl sulphoacetates, alkylether phosphates, acyl sarcosinates, acyl isethionates and N-acyl taurates, the alkyl or acyl radical of all these various compounds for example having from 8 to 24 carbon atoms, and an aryl radical such as a phenyl or benzyl group.

According to at least one embodiment, the salts include those of fatty acids, such as the salts of oleic, ricinoleic, palmitic, stearic acids, acids of copra oil or of hydrogenated copra oil, acyl lactylates whose acyl radical has 8 to 20 carbon atoms, alkyl D-galactoside uronic acids and their salts as well as the polyoxyalkylenated alkyl(C6-C24)ether carboxylic acids, the polyoxyalkylenated alkyl(C6-C24)aryl ether carboxylic acids, the polyoxyalkylenated alkyl(C6-C24)amido-ether carboxylic acids and their salts, for example those having from 2 to 50 ethylene oxide groups, and mixtures thereof.

A representative, non-limiting list of amphoteric surfactants includes, alone or mixed, the derivatives of secondary or tertiary aliphatic amines wherein the aliphatic radical is a linear and branched chain with 8 to 22 carbon atoms and comprises at least one hydrosolubilizing anionic group (for example carboxylate, sulphonate, sulphate, phosphate or phosphonate); the alkyl(C8-C20) betaines, the sulphobetaines, the alkyl(C8-C20)amidoalkyl(C1-C6) betaines such as cocoamidopropyl betaine or the alkyl(C8-C20)amidoalkyl(C1-C6) sulphobetaines.

A representative, non-limiting list of non-ionic surfactants includes, alone or mixed, alcohols, alpha-diols, alkyl phenols or polyethoxylated, polypropoxylated or polyglycerolated fatty acids, having an aliphatic chain with for example 8 to 18 carbon atoms, where the number of ethylene oxide or propylene oxide groups can optionally be in the range from 2 to 50 and the number of glycerol groups can optionally be in the range from 2 to 30.

Any plasticizer known in the pharmaceutical art is suitable for use in the film product. These include, but are not limited to, polyethylene glycol; glycerin; sorbitol; triethyl citrate; tribuyl citrate; dibutyl sebecate; vegetable oils such as castor oil; surfactants such as polysorbates, sodium lauryl sulfates, and dioctyl-sodium sulfosuccinates; propylene glycol; mono acetate of glycerol; diacetate of glycerol; triacetate of glycerol; natural gums and mixtures thereof.

The film product of the present invention may also contain at least one colorant, such as a pigment or dyestuff. Examples of suitable pigments include, but are not limited to, inorganic pigments, organic pigments, lakes, pearlescent pigments, irridescent or optically variable pigments, and mixtures thereof. A pigment should be understood to mean inorganic or organic, white or colored particles. Said pigments may optionally be surface-treated within the scope of the present invention but are not limited to treatments such as silicones, perfluorinated compounds, lecithin, and amino acids.

Representative examples of inorganic pigments useful in the present invention include those selected from the group consisting of rutile or anatase titanium dioxide, coded in the Color Index under the reference CI 77,891; black, yellow, red and brown iron oxides, coded under references CI 77,499, 77,492 and, 77,491; manganese violet (CI 77,742); ultramarine blue (CI 77,007); chromium oxide (CI 77,288); chromium hydrate (CI 77,289); and ferric blue (CI 77,510) and mixtures thereof.

Representative examples of organic pigments and lakes useful in the present invention include, but are not limited to, D&C Red No. 19 (CI 45,170), D&C Red No. 9 (CI 15,585), D&C Red No. 21 (CI 45,380), D&C Orange No. 4 (CI 15,510), D&C Orange No. 5 (CI 45,370), D&C Red No. 27 (CI 45,410), D&C Red No. 13 (CI 15,630), D&C Red No. 7 (CI 15,850), D&C Red No. 6 (CI 15,850), D&C Yellow No. 5 (CI 19,140), D&C Red No. 36 (CI 12,085), D&C Orange No. 10 (CI 45,425), D&C Yellow No. 6 (CI 15,985), D&C Red No. 30 (CI 73,360), D&C Red No. 3 (CI 45,430) and the dye or lakes based on cochineal carmine (CI 75,570) and mixtures thereof.

Representative examples of pearlescent pigments useful in the present invention include those selected from the group consisting of the white pearlescent pigments such as mica coated with titanium oxide, mica coated with titanium dioxide, bismuth oxychloride, titanium oxychloride, colored pearlescent pigments such as titanium mica with iron oxides, titanium mica with ferric blue, chromium oxide and the like, titanium mica with an organic pigment of the above-mentioned type as well as those based on bismuth oxychloride and mixtures thereof.

The precise amount and type of colorant employed in the cosmetic compositions of the invention will depend on the color, intensity and use of the cosmetic composition and, as a result, will be determined by those skilled in the art of cosmetic formulation.

Any thickener known in the art may optionally be added to the film. Suitable thickeners include, but are not limited to, cyclodextrin, crystallizable carbohydrates, and the like, and derivatives and combinations thereof. Suitable crystallizable carbohydrates include the monosaccharides and the oligosaccharides. Of the monosaccharides, the aldohexoses e.g., the D and L isomers of allose, altrose, glucose, mannose, gulose, idose, galactose, talose, and the ketohexoses e.g., the D and L isomers of fructose and sorbose along with their hydrogenated analogs: e.g., glucitol (sorbitol), and mannitol are preferred. Of the oligosaccharides, the 1,2-disaccharides sucrose and trehalose, the 1,4-disaccharides maltose, lactose, and cellobiose, and the 1,6-disaccharides gentiobiose and melibiose, as well as the trisaccharide raffinose are preferred along with the isomerized form of sucrose known as isomaltulose and its hydrogenated analog isomalt. Other hydrogenated forms of reducing disaccharides (such as maltose and lactose), for example, maltitol and lactitol are also preferred. Additionally, the hydrogenated forms of the aldopentoses: e.g., D and L ribose, arabinose, xylose, and lyxose and the hydrogenated forms of the aldotetroses: e.g., D and L erythrose and threose are suitable and are exemplified by xylitol and erythritol, respectively.

Preservatives known in the art may optionally be added to the film. Suitable Preservatives include, but are not limited to Benzalkonium Chloride, Benzyl Alcohol, 2-Bromo-2-Nitropropane, Butylparaben, Chlorhexidine Digluconate, Chlorphenism, Dehydroacetic Acid, Citric Acid, Diazolidinyl Urea, DMDM Hydantoin, Ethylparaben, Formaldahyde, Imidazolidinyl Urea, Isobutylparaben, Methylisothiazolinone, Methylparaben, Phenoxyethanol, Polyaminopropyl biguanide, Potassium Sorbate, Propylparaben, Quaternium—15, Salicylic Acid, Sodium benzoate, Sodium Dehydroacetate, Sodium Metabisulfite, Sodium Salicylate, Sodium Sulfite, Sorbic Acid, Stearalkonium Chloride, Triclosan, and Zinc Pyrithione.

In some embodiments, “microbeads” or other particulate materials may be incorporated and used as “scrubbing particles” or “exfoliates” in film products used in personal care products such as facial scrubs and body washes. The microbeads are small particles, generally having a particle size of less than about 1,000 μm, often less than about 750 μm. Often, topical compositions and/or skin cleansing compositions incorporate microbeads or particulates having a size of less than about 300 μm, and preferably, less than about 100 μm. Particulates, such as pumice can range from 35-1400 μm; topical compositions generally employ pumice having a particle size of about 100 μm. The particle size should be taken into consideration when employing a screen mask, as the particle size is generally less than about ⅓ of the opening in the screen. For larger particles it is more advantages to use stencil because there are screen limitations to consider. The microbeads can be a generally homogeneous material and can comprise pumice, polyethylene, glass, aluminum oxide, titanium dioxide, celluloses, such as Hydroxypropyl Methylcellulose (HPMC), or Vitamin E. Alternatively, the microbeads can be in the form of microencapsulated particles in which desirable material is encapsulated in a covering material to delay the release of the material to the environment. The microencapsulated particle may include adhesives and/or one or more benefit agents described in more detail below.

In a preferred embodiment, the film-forming composition, for example as shown in FIG. 6B, includes a benefit agent. The resulting integral film product 212 has a first surface 220 formed on the releasable surface 206 of the substrate 204, and a second surface 222 opposite thereof defined by the upper edges 216. The first surface 220 is arranged and configured to deliver the benefit agent therethrough. For example, the first surface 220 may be protected by a release liner on a flexible substrate during manufacture and storage prior to use by a consumer. On the other hand, the second surface 222 is exposed to ambient conditions during the solidifying of the raw shape 210. Thus, the first surface 220 may be tacky after removal from the substrate 204, and it may adhere to the skin of a consumer. The second surface 222 may “dry out” during transformation to the integral film product 212. Thus, the tacky first surface 220 is ideal for delivery of a benefit agent to the skin of the consumer.

As used herein the specification and the claims, the term “benefit agent” and variants thereof relates to an element, an ion, a compound (e.g., a synthetic compound or a compound isolated from a natural source) or other chemical moiety in solid (e.g. particulate), liquid, or gaseous state and compound that has a cosmetic or therapeutic effect on the skin.

The compositions of the present invention may further include one or more benefit agents or pharmaceutically-acceptable salts and/or esters thereof, the benefit agents generally capable of interacting with the skin to provide a benefit thereto. As used herein, the term “benefit agent” includes any active ingredient that is to be delivered into and/or onto the skin at a desired location, such as a cosmetic or pharmaceutical.

The benefit agents useful herein may be categorized by their therapeutic benefit or their postulated mode of action. However, it is to be understood that the benefit agents useful herein may, in some circumstances, provide more than one therapeutic benefit or operate via greater than one mode of action. Therefore, the particular classifications provided herein are made for the sake of convenience and are not intended to limit the benefit agents to the particular application(s) listed. Examples of suitable benefit agents include those that provide benefits to the skin, such as, but not limited to, depigmentation agents; reflectants; film forming polymers; amino acids and their derivatives; antimicrobial agents; allergy inhibitors; anti-acne agents; anti-aging agents; anti-wrinkling agents, antiseptics; analgesics; shine-control agents; antipruritics; local anesthetics; anti-hair loss agents; hair growth promoting agents; hair growth inhibitor agents, antihistamines; anti-infectives; anti-inflammatory agents; anticholinergics; vasoconstrictors; vasodilators; wound healing promoters; peptides, polypeptides and proteins; deodorants and antiperspirants; medicament agents; skin firming agents, vitamins; skin lightening agents; skin darkening agents; antifungals; depilating agents; counterirritants; hemorrhoidals; insecticides; enzymes for exfoliation or other functional benefits; enzyme inhibitors; poison ivy products; poison oak products; burn products; anti-diaper rash agents; prickly heat agents; vitamins; herbal extracts; vitamin A and its derivatives; flavenoids; sensates; anti-oxidants; hair lighteners; sunscreens; anti-edema agents, neo-collagen enhancers, film-forming polymers, chelating agents; anti-dandruff/sebhorreic dermatitis/psoriasis agents; keratolytics; and mixtures thereof.

In addition the benefit agent may also provide passive benefits to the skin. As such, the benefit agent may be formulated into a composition that include such ingredients as humectants or emollients, softeners or conditioners of the skin, make-up preparations, and mixtures thereof.

Examples of suitable anti-edema agents nonexclusively include bisabolol natural, synthetic bisabolol, corticosteroids, beta-glucans, and mixtures thereof.

Examples of suitable vasoconstrictors nonexclusively include horse chestnut extract, prickly ash, peroxides, tetrahydrozaline, and mixtures thereof.

Examples of suitable anti-inflammatory agents nonexclusively include benoxaprofen, centella asiatica, bisabolol, feverfew (whole), feverfew (parthenolide free), green tea extract, green tea concentrate, hydrogen peroxide, salicylates, oat oil, chamomile, and mixtures thereof.

Examples of neo-collagen enhancers nonexclusively include vitamin A and its derivatives (e.g. beta-carotene and retinoids such as retinoic acid, retinal, retinyl esters such as and retinyl palmitate, retinyl acetate and retinyl propionate); vitamin C and its derivatives such as ascorbic acid, ascorbyl phosphates, ascorbyl palmitate and ascorbyl glucoside; copper peptides; simple sugars such as lactose, mellibiose and fructose; and mixtures thereof.

Examples of enzymes include papain, bromelain, pepsin, and trypsin.

Examples of suitable skin firming agent nonexclusively include alkanolamines such as dimethylaminoethanol (“DMAE”).

Examples of suitable antipruritics and skin protectants nonexclusively include oatmeal, beta-glucan, feverfew, soy products (by “soy product,” it is meant a substance derived from soybeans, as described in United States Patent Application 2002-0160062), bicarbonate of soda, colloidal oatmeal, Anagallis Arvensis, Oenothera Biennis, Verbena Officinalis, and the like. As used herein, colloidal oatmeal means the powder resulting from the grinding and further processing of whole oat grain meeting United States Standards for Number 1 or Number 2 oats. The colloidal oatmeal has a particle size distribution as follows: not more than 3 percent of the total particles exceed 150 micrometers in size and not more than 20 percent of the total particles exceed 75 micrometers in size. Examples of suitable colloidal oatmeals include, but are not limited to, “Tech-O” available from the Beacon Corporation (Kenilworth, N.J.) and colloidal oatmeals available from Quaker (Chicago, Ill.).

Examples of suitable reflectants nonexclusively include mica, alumina, calcium silicate, glycol dioleate, glycol distearate, silica, sodium magnesium fluorosilicate, and mixtures thereof.

Examples of skin darkening agents nonexclusively include dihydroxy acetone, erythulose, melanin, and mixtures thereof.

Suitable film forming polymers include those that, upon drying, produce a substantially continuous coating or film on the skin or nails. Nonexclusive examples of suitable film forming polymers include acrylamidopropyl trimonium chloride/acrylamide copolymer; corn starch/acrylamide/sodium acrylate copolymer; polyquaternium-10; polyquaternium-47; polyvinylmethylether/maleic anhydride copolymer; styrene/acrylates copolymers; and mixtures thereof.

Commercially available humectants which are capable of providing moisturization and conditioning properties nonexclusively include: (i) water soluble liquid polyols selected from the group comprising glycerine, propylene glycol, hexylene glycol, butylene glycol, pentylene glycol, dipropylene glycol, and mixtures thereof; (ii) polyalkylene glycol of the formula HO—(R″O)b-H wherein R″ is an alkylene group having from about 2 to about 4 carbon atoms and b is an integer of from about 1 to about 10, such as PEG 4; (iii) polyethylene glycol ether of methyl glucose of formula CH3-C6H10O5-(OCH2CH2)c-OH wherein c is an integer from about 5 to about 25; (iv) urea; (v) fructose; (vi) glucose; (vii) honey; (viii) lactic acid; (ix) maltose; (x) sodium glucuronate; and (xi) mixtures thereof, with glycerine being an exemplary humectant.

Suitable amino acids and derivatives include amino acids derived from the hydrolysis of various proteins as well as the salts, esters, and acyl derivatives thereof. Examples of such amino acid agents nonexclusively include amphoteric amino acids such as alkylamido alkylamines, i.e. stearyl acetyl glutamate, capryloyl silk amino acid, capryloyl collagen amino acids; capryloyl keratin amino acids; capryloyl pea amino acids; cocodimonium hydroxypropyl silk amino acids; corn gluten amino acids; cysteine; glutamic acid; glycine; hair keratin amino acids; amino acids such as aspartic acid, threonine, serine, glutamic acid, proline, glycine, alanine, cystine, valine, methionine, isoleucine, leucine, tyrosine, phenylalanine, cysteic acid, lysine, histidine, arginine, cysteine, tryptophan, citrulline; lysine; silk amino acids, wheat amino acids; and mixtures thereof.

Suitable proteins include those polymers that have a long chain, i.e. at least about 10 carbon atoms, and a high molecular weight, i.e. at least about 1000, and are formed by self-condensation of amino acids. Nonexclusive examples of such proteins include collagen, deoxyribonuclease, iodized corn protein; milk protein; protease; serum protein; silk; sweet almond protein; wheat germ protein; wheat protein; alpha and beta helix of keratin proteins; hair proteins, such as intermediate filament proteins, high-sulfur proteins, ultrahigh-sulfur proteins, intermediate filament-associated proteins, high-tyrosine proteins, high-glycine tyrosine proteins, tricohyalin, and mixtures thereof.

Examples of suitable vitamins nonexclusively include various forms of vitamin B complex, including thiamine, nicotinic acid, biotin, pantothenic acid, choline, riboflavin, vitamin B3, vitamin B6, vitamin B12, pyridoxine, inositol, carnitine; vitamins A,C,D,E,K and their derivatives such as vitamin A palmitate and pro-vitamins, e.g. (i.e., panthenol (pro vitamin B5) and panthenol triacetate) and mixtures thereof.

Examples of suitable antimicrobial agents nonexclusively include bacitracin, erythromycin, neomycin, tetracycline, chlortetracycline, benzethonium chloride, phenol, benzyl peroxide, metal salts or ions such as silver and its salts and mixtures thereof.

Examples of suitable skin emollients and skin moisturizers nonexclusively include mineral oil, lanolin, vegetable oils, isostearyl isostearate, glyceryl laurate, methyl gluceth-10, methyl gluceth-20 chitosan, and mixtures thereof.

An example of a suitable hair softener nonexclusively includes silicone compounds, such as those that are either non-volatile or volatile and those that are water soluble or water insoluble. Examples of suitable silicones include organo-substituted polysiloxanes, which are either linear or cyclic polymers of monomeric silicone/oxygen monomers and which nonexclusively include cetyl dimethicone; cetyl triethylammonium dimethicone copolyol phthalate; cyclomethicone; dimethicone copolyol; dimethicone copolyol lactate; hydrolyzed soy protein/dimethicone copolyol acetate; silicone quaternium 13; stearalkonium dimethicone copolyol phthalate; stearamidopropyl dimethicone; and mixtures thereof.

Examples of sunscreens, nonexclusively include benzophenones, bornelone, butyl paba, cinnamidopropyl trimethyl ammonium chloride, disodium distyrylbiphenyl disulfonate, PABA and its derivatives (such as octyl dimethyl PABA, butyl methoxydibenzoylmethane, isoamyl methoxycinnamate, methyl benzilidene camphor, octyl triazole, octyl methoxycinnamate, oxybenzone, octocrylene, octyl salicylate, homosalate, phenylbenzimidazole sulfonic acid, ethyl hydroxypropyl aminobenzoate, menthyl anthranilate, aminobenzoic acid, cinoxate, diethanolamine methoxycinnamate, glyceryl aminobenzoate, titanium dioxide, zinc oxide, oxybenzone, Padimate O, red petrolatum, MEXORYL S and SX, TINOSORB M and S, and mixtures thereof.

Examples of skin lightening agents nonexclusively include hydroquinone, catechol and its derivatives, ascorbic acid and its derivatives, and mixtures thereof.

Examples of suitable insecticides (including insect repellents, anti-scabies and anti-lice treatments) nonexclusively include permethrin, pyrethrin, piperonyl butoxide, imidacloprid, N,N-diethyl toluamide, which refers to the material containing predominantly the meta isomer, i.e., N,N-diethyl-m-toluamide, which is also known as DEET, natural or synthetic pyrethroids, whereby the natural pyrethroids are contained in pyrethrum, the extract of the ground flowers of Chrysanthemum cinerariaefolium or C. coccineum; and mixtures thereof. Within the structure of Formula III. are ethyl 3-(N-butylacetamido)propionate, wherein R7 is a CH3 group, R5 is an n-butyl group, R6 is H, K is COOR8 and R8 is ethyl, which is available commercially from Merck KGaA of Darmstadt, Germany under the name, “Insect Repellent 3535.”

Examples of an anti-fungal for foot preparation nonexclusively include tolnaftate and myconozole.

Examples of suitable depilating agents nonexclusively include calcium thioglycolate, magnesium thioglycolate, potassium thioglycolate, strontium thioglycolate, and mixtures thereof.

Examples of suitable analgesics such as external analgesics and local anesthetics nonexclusively include benzocaine, dibucaine, benzyl alcohol, camphor, capsaicin, capsicum, capsicum oleoresin, juniper tar, menthol, methyl nicotinate, methyl salicylate, phenol, resorcinol, turpentine oil, and mixtures thereof.

Examples of suitable antiperspirants and deodorants nonexclusively include aluminium chlorohydrates, aluminium zirconium chlorohydrates, and mixtures thereof.

Examples of suitable counterirritants nonexclusively include camphor, menthol, methyl salicylate, peppermint and clove oils, ichtammol, and mixtures thereof.

An example of a suitable inflammation inhibitor nonexclusively includes hydrocortisone, Fragaria Vesca, Matricaria Chamomilla, and Salvia Officinalis.

Examples of suitable anaesthetic ingredients nonexclusively include the benzocaine, pramoxine hydrochloride, lidocaine, betacaine and mixtures thereof; antiseptics such as benzethonium chloride; astringents such as zinc oxide, bismuth subgallate, balsam Peru, and mixtures thereof; skin protectants such as zinc oxide, silicone oils, petrolatum, cod liver oil, vegetable oil, and mixtures thereof.

Examples of such suitable benefits agents effective in the treatment of dandruff, seborrheic dermatitis, and psoriasis, as well as the symptoms associated therewith nonexclusively include zinc pyrithione, anthralin, shale oil and derivatives thereof such as sulfonated shale oil, selenium sulfide, sulfur; salicylic acid; coal tar; povidone-iodine, imidazoles such as ketoconazole, dichlorophenyl imidazolodioxalan (“elubiol”), clotrimazole, itraconazole, miconazole, climbazole, tioconazole, sulconazole, butoconazole, fluconazole, miconazole nitrate and any possible stereo isomers and derivatives thereof; piroctone olamine (Octopirox); ciclopirox olamine; anti-psoriasis agents such as vitamin D analogs, e.g. calcipotriol, calcitriol, and tacaleitrol; vitamin A analogs such as esters of vitamin A, e.g. vitamin A palmitate and vitamin A acetate, retinyl propionate, retinaldehyde, retinol, and retinoic acid; corticosteroids such as hydrocortisone, clobetasone, butyrate, clobetasol propionate menthol, pramoxine hydrochloride, and mixtures thereof.

Examples of benefit agents suitable for treating hair loss include, but are not limited to potassium channel openers or peripheral vasodilators such as minoxidil, diazoxide, and compounds such as N*-cyano-N-(tert-pentyl)-N′-3-pyridinyl-guanidine (“P-1075”); saw palmetto extract, vitamins, such as vitamin E and vitamin C, and derivatives thereof such as vitamin E acetate and vitamin C palmitate; hormones, such as erythropoietin, prostaglandins, such as prostaglandin El and prostaglandin F2-alpha; fatty acids, such as oleic acid; diruretics such as spironolactone; heat shock proteins (‘HSP”), such as HSP 27 and HSP 72; calcium channel blockers, such as verapamil HCL, nifedipine, and diltiazemamiloride; immunosuppressant drugs, such as cyclosporin and Fk-506; 5 alpha-reductase inhibitors such as finasteride; growth factors such as, EGF, IGF and FGF; transforming growth factor beta; tumor necrosis factor; non-steroidal anti-inflammatory agents such as benoxaprofen; retinoids such as retinal and tretinoin; cytokines, such as IL-6, IL-1 alpha, and IL-1 beta; cell adhesion molecules such as ICAM; glucorcorticoids such as betametasone; botanical extracts such as aloe, clove, ginseng, rehmannia, swertia, sweet orange, zanthoxylum, Serenoa repens (saw palmetto), Hypoxis rooperi, stinging nettle, pumpkin seeds, and rye pollen; other botanical extracts including sandlewood, red beet root, chrysanthemum, rosemary, burdock root and other hair growth promoter activators; homeopathic agents such as Kalium Phosphoricum D2, Azadirachta indica D2, and Joborandi DI; genes for cytokines, growth factors, and male-pattered baldness; antifungals such as ketoconazole and elubiol; antibiotics such as streptomycin; proteins inhibitors such as cycloheximide; acetazolamide; benoxaprofen; cortisone; diltiazem; hexachlorobenzene; hydantoin; nifedipine; penicillamine; phenothaiazines; pinacidil; psoralens, verapamil; zidovudine; alpha-glucosylated rutin having at least one of the following rutins: quercetin, isoquercitrin, hespeddin, naringin, and methylhesperidin, and flavonoids and transglycosidated derivatives thereof; and mixtures thereof.

Examples of benefit agents suitable for use in inhibiting hair growth include: serine proteases such as trypsin; vitamins such as alpha-tocophenol (vitamin E) and derivatives thereof such as tocophenol acetate and tocophenol palmitate; antineoplastic agents, such as doxorubicin, cyclophosphamide, chlormethine, methotrexate, fluorouracil, vincristine, daunorubicin, bleomycin and hydroxycarbamide; anticoagulants, such as heparin, heparinoids, coumaerins, detran and indandiones; antithyroid drugs, such as iodine, thiouracils and carbimazole; lithium and lithium carbonate; interferons, such as interferon alpha, interferon alpha-2a and interferon alpha-2b; retinoids, such as retinol (vitamin A), isotretinoin: glucocorticoids such as betamethasone, and dexamethosone; antihyperlipidaemic drugs, such as triparanol and clofibrate; thallium; mercury; albendazole; allopurinol; amiodarone; amphetamines; androgens; bromocriptine; butyrophenones; carbamazepine; cholestyramine; cimetidine; clofibrate; danazol; desipramine; dixyrazine; ethambutol; etionamide; fluoxetine; gentamicin, gold salts; hydantoins; ibuprofen; impramine; immunoglobulins; indandiones; indomethacin; intraconazole; levadopa; maprotiline; methysergide; metoprolol; metyrapone; nadolol; nicotinic acid; potassium thiocyanate; propranolol; pyridostimine; salicylates; sulfasalazine; terfenadine; thiamphenicol; thiouracils; trimethadione; troparanol; valproic acid; and mixtures thereof.

Examples of suitable anti-aging agents include, but are not limited to inorganic sunscreens such as titanium dioxide and zinc oxide; organic sunscreens such as octyl-methoxy cinnamates and derivatives thereof; retinoids; copper containing peptides; vitamins such as vitamin E, vitamin A, vitamin C, vitamin B, and derivatives thereof such as vitamin E acetate, vitamin C palmitate, and the like; antioxidants including beta carotene, alpha hydroxy acids such as glycolic acid, citric acid, lactic acid, malic acid, mandelic acid, ascorbic acid, alpha-hydroxybutyric acid, alpha-hydroxyisobutyric acid, alpha-hydroxyisocaproic acid, atrrolactic acid, alpha-hydroxyisovaleric acid, ethyl pyruvate, galacturonic acid, glucoheptonic acid, glucoheptono 1,4-lactone, gluconic acid, gluconolactone, glucuronic acid, glucuronolactone, glycolic acid, isopropyl pyruvate, methyl pyruvate, mucic acid, pyruvic acid, saccharic acid, saccaric acid 1,4-lactone, tartaric acid, and tartronic acid; beta hydroxy acids such as beta-hydroxybutyric acid, beta-phenyl-lactic acid, beta-phenylpyruvic acid; polyphenolics; botanical extracts such as green tea, soy products, milk thistle, algae, aloe, angelica, bitter orange, coffee, goldthread, grapefruit, hoellen, honeysuckle, Job's tears, lithospermum, mulberry, peony, puerarua, nice, safflower, and mixtures thereof.

Examples of suitable anti-acne agents include, but are not limited to topical retinoids (tretinoin, isotretinoin, motretinide, adapalene, tazarotene, azelaic acid, retinol); salicylic acid; benzoyl peroxide; resorcinol; antibiotics such as tetracycline and isomers thereof, erythromycin, and the anti-inflammatory agents such as ibuprofen, naproxen, hetprofen; botanical extracts such as alnus, arnica, artemisia capillaris, asiasarum root, birrh, calendula, chamomile, cnidium, comfrey, fennel, galla rhois, hawthorn, houttuynia, hypericum, jujube, kiwi, licorice, magnolia, olive, peppermint, philodendron, salvia, sasa albo-marginata; imidazoles such as ketoconazole and elubiol.

Examples of suitable depigmentation agents include, but are not limited to soy products, retinoids such as retinol; Kojic acid and its derivatives such as, for example, kojic dipalmitate; hydroquinone and it derivatives such as arbutin; transexamic acid; vitamins such as niacin, vitamin C and its derivatives; azelaic acid; placertia; licorice; extracts such as chamomile and green tea, and mixtures thereof, with retinoids, Kojic acid, soy products, and hydroquinone being particularly suitable examples.

Examples of suitable anti-hemorrhoidal products include, but are not limited to anesthetics such as benzocaine, pramoxine hydrochloride, and mixtures thereof; antiseptics such as benzethonium chloride; astringents such as zinc oxide, bismuth subgallate, balsam Peru, and mixtures thereof; skin protectants such as cod liver oil, vegetable oil, and mixtures thereof.

Examples of vasodilators include, but are not limited to minoxidil, diazoxide, and compounds such as N*-cyano-N-(tert-pentyl)-N′-3-pyridinyl-guanidine (“P-1075”).

Examples of suitable shine-control agents include, but are not limited to hydrated silica, kaolin, and bentonite. Examples of suitable anti-histamines include, but are not limited to diphenhydramine HCl.

Examples of suitable antiinfectives include, but are not limited to benzalkonium chloride, hexamidine, and hydrogen peroxide. Examples of suitable wound healing promoters include, but are not limited to chitosan and its derivatives. Examples of suitable poison ivy and poison oak products include, but are not limited to bentonite, hydrocortisone, menthol, and lidocaine. Examples of burn products include, but are not limited to benzocaine and lidocaine. Examples of suitable anti-diaper rash products include but are not limited to zinc oxide and petrolatum. Examples of suitable prickly heat products include, but are not limited to zinc oxide. Examples of suitable sensates include, but are not limited to menthol, fragrances, and capsaicin.

Benefit agents that may be particularly suitable for use with the present invention include, DMAE, soy products, colloidal oatmeal, sulfonated shale oil, olive leaf, elubiol, 6-(1-piperidinyl)-2,4-pyrimidinediamine-3-oxide, finasteride, ketoconazole, salicylic acid, zinc pyrithione, coal tar, benzoyl peroxide, selenium sulfide, hydrocortisone, sulfur, menthol, pramoxine hydrochloride, tricetylmonium chloride, polyquaternium 10, panthenol, panthenol triacetate, vitamin A and derivatives thereof, vitamin B and derivatives thereof, vitamin C and derivatives thereof, vitamin D and derivatives thereof, vitamin E and derivatives thereof, vitamin K and derivatives thereof, keratin, lysine, arginine, hydrolyzed wheat proteins, copper containing compounds such as copper containing peptides and copper salts, hydrolyzed silk proteins, octyl methoxycinnamate, oxybenzone, avobenzone, minoxidil, saw palmetto extract, titanium dioxide, zinc dioxide, retinol, erthromycin, tretinoin, and mixtures thereof.

Other benefit agents that may be include neo-collagen promoters (e.g. retinoids such as retinal and copper-containing peptides), skin firming agents (e.g. DMAE), and depigmenting agents (e.g. soy).

The amount of the benefit agent that may be used may vary depending upon, for example, the ability of the benefit agent to penetrate through the skin or nail, the specific benefit agent chosen, the particular benefit desired, the sensitivity of the user to the benefit agent, the health condition, age, and skin and/or nail condition of the user, and the like. In sum, the benefit agent is used in a “safe and effective amount,” which is an amount that is high enough to deliver a desired skin or nail benefit or to modify a certain condition to be treated, but is low enough to avoid serious side effects, at a reasonable risk to benefit ratio within the scope of sound medical judgment.

The benefit agent may be formulated, mixed, or compounded with other ingredients into a composition (e.g. liquid, emulsion, cream, and the like) wherein the other ingredients do not detract from the functionality of the benefit agent. A delivery agent that enhances the absorption of the one or more benefit agents into the skin may be formulated with the benefit agent to fulfill this function. Suitable delivery agents include, for example, sulfoxides, alcohols such as ethanol; fatty acids such as, for example, linoleic acid or oleic acid, fatty esters such as, for example, may be produced from reacting a C3-C10 carboxylic acid with a C10-C20 fatty alcohol; a polyol, an alkane, an amine, an amide, a turpene, a surfactant, a cyclodextrin or combinations thereof among other agents known to the art to be suitable for enhancing the penetration of various benefit agents through the stratum corneum into deeper layers of the skin.

The concentration of the benefit agent within the composition is variable. Unless otherwise expressed herein, typically the benefit agent is present in the composition in an amount, based upon the total weight of the composition/system, from about 0.01 percent to about 20 percent, such as from about 0.01 percent to about 5 percent (e.g., from about 0.01 percent to about 1 percent).

This composition that includes the benefit agent may also serve as a coupling composition as described previously and may include ingredients that enable the composition to possess one of these functions.

In addition to, or in place of one or more of the components described above, fragrances, flavors, sweeteners, coloring agents, pigments, dyes and the like may be added to the film-forming composition of the present invention.

### EXAMPLES

The present invention will be further understood by reference to the following specific Examples that are illustrative of the composition, form and method of producing the device of the present invention. It is to be understood that many variations of composition, form and method of producing the device would be apparent to those skilled in the art. The following Examples, wherein parts and percentages are by weight unless otherwise indicated, are only illustrative.

Film-forming compositions were prepared with the %-solids and viscosity values in the Table 1, below:

TABLE 1

| | Composition | | | |
|---|---|---|---|---|
| | | Weight | %- | Viscos- |
| Formula | Ingredient | (g) | solids | ity (cP)¹ |
| 1 | FD&C Red 40 | 0.02 | 24 | 6650 |
| | Keltrol CG-T, Xanthan Gum | 0.04 | | |
| | TIC Pretested Locust Bean Gum | 0.07 | | |
| | POR/A Powder | | | |
| | Copper Gluconate Powder | 0.36 | | |
| | Acesulfame K, Particle Size A | 0.51 | | |
| | Thymol | 0.15 | | |
| | Methyl Salicylate | 0.22 | | |
| | Eucalyptol USP | 0.25 | | |
| | Polysorbate 80 N.F. | 0.35 | | |
| | Atmos 300K | 0.35 | | |
| | Ticaloid 750 Carrageenan | 0.35 | | |
| | Pullulan, Cosmetic Grade | 16.48 | | |
| | Sucralose, Micronized NF | 1.01 | | |
| | Cinnamon Flavor SN313574 | 1.25 | | |
| | Menthol USP TA | 2.39 | | |
| | Water, Purified | 76.20 | | |
| 2 | FD&C Red 40 | 0.02 | 30 | 17950 |
| | Keltrol CG-T, Xanthan Gum | 0.04 | | |
| | TIC Pretested Locust Bean Gum | 0.07 | | |
| | POR/A Powder | | | |
| | Copper Gluconate Powder | 0.36 | | |
| | Acesulfame K, Particle Size A | 0.51 | | |
| | Thymol | 0.15 | | |
| | Methyl Salicylate | 0.22 | | |
| | Eucalyptol USP | 0.25 | | |
| | Polysorbate 80 N.F. | 0.35 | | |
| | Atmos 300K | 0.35 | | |
| | Ticaloid 750 Carrageenan | 0.35 | | |
| | Pullulan, Cosmetic Grade | 16.48 | | |
| | Sucralose, Micronized NF | 1.01 | | |
| | Cinnamon Flavor SN313574 | 1.25 | | |
| | Menthol USP TA | 2.39 | | |
| | Water, Purified | 55.00 | | |
| 3 | FD&C Red 40 | 0.0200 | 38 | 90800 |
| | Keltrol CG-T, Xanthan Gum | 0.0400 | | |
| | TIC Pretested Locust Bean Gum | 0.0700 | | |
| | POR/A Powder | | | |
| | Copper Gluconate Powder | 0.36 | | |
| | Acesulfame K, Particle Size A | 0.51 | | |
| | Thymol | 0.15 | | |
| | Methyl Salicylate | 0.22 | | |
| | Eucalyptol USP | 0.25 | | |
| | Polysorbate 80 N.F. | 0.35 | | |
| | Atmos 300K | 0.35 | | |
| | Ticaloid 750 Carrageenan | 0.35 | | |
| | Pullulan, Cosmetic Grade | 16.48 | | |
| | Sucralose, Micronized NF | 1.01 | | |
| | Cinnamon Flavor SN313574 | 1.25 | | |
| | Menthol USP TA | 2.39 | | |
| | Water, Purified | 55.00 | | |
| 4 | SELVOL 805 | 22.973 | 25 | 1350 |
| | Polysorbate 80 | 1.750 | | |
| | Dow Corning 2501 Cosmetic Wax | 0.800 | | |
| | Kester Wax K-24 | 0.800 | | |
| | Glycerin 99.7%, USP | 2.125 | | |
| | Water, purified | 85.000 | | |
| 5 | Selvol 805 | 22.9730 | 38 | 57600 |
| | Polysorbate 80 | 1.7500 | | |
| | Dow Corning 2501 Cosmetic Wax | 0.8000 | | |
| | Kester Wax K-24 | 0.8000 | | |
| | Glycerin 99.7%, USP | 2.1250 | | |
| | Water, Purified | 45.0000 | | |

| | | | |
|---|---|---|---|
| 6 | RED ink Speedball² #4601 | — | 17450 |
| 7 | BLACK ink Speedball² #4600 | — | 20050 |

¹Viscosity in centipoise (cP) was measured with a calibrated Brookfield Viscometer.
The test method was standardized to:
Temperature: 70° F. (21° C.)
Spindle # RV S06
Motor speed 20 rpm.
²The screen printing ink used for testing is manufactured by Speedball Art Products, LLC, 2301 Speedball Road, Statesville, NC 28677 USA, % solids was not recorded.

### Examples 1-18

### Stencil Printing

Stencil material: plastic shim stock, shape cut-out via laser, substrate poly coated paper (ULINE® Freezer Paper #S7045. 40 lb. virgin paper bleached white and coated with 5 lb. polyethylene on one side, available from Uline, Pleasant Prairie, Wis., USA).

Stenciling done on the flat, by hand, over smooth flat glass backup, with 4″ wide stiff scraper blade (similar putty knife and/or dry wall tool can substitute for the blade)

Five of the film-forming compositions of Table 1 were deposited using a blade and a stencil with the thickness in Table 2 below. The resulting integral film products were dried, removed from the substrate, and measured.

TABLE 2

| | | Stencil | Stencil | Avg. Dry |
|---|---|---|---|---|
| Example | | Thickness | Thickness | Thickness³ |
| # | Formula | (inch) | (mm) | (in) |
| 1 | 1 | 0.005 | 0.13 | 0.002 |
| 2 | 1 | 0.007 | 0.18 | 0.002 |
| 3 | 1 | 0.010 | 0.25 | 0.003 |
| 4 | 1 | 0.020 | 0.51 | 0.005 |
| 5 | 1 | 0.030 | 0.76 | 0.007 |
| 6 | 1 | 0.040 | 1.02 | 0.011 |
| 7 | 2 | 0.005 | 0.13 | 0.003 |
| 8 | 2 | 0.007 | 0.18 | 0.003 |
| 9 | 2 | 0.010 | 0.25 | 0.004 |
| 10 | 2 | 0.020 | 0.51 | 0.007 |
| 11 | 2 | 0.030 | 0.76 | 0.011 |
| 12 | 2 | 0.040 | 1.02 | 0.014 |
| 13 | 3 | 0.005 | 0.13 | 0.004 |
| 14 | 3 | 0.007 | 0.18 | 0.005 |
| 15 | 3 | 0.010 | 0.25 | 0.006 |
| 16 | 3 | 0.020 | 0.51 | 0.009 |
| 17 | 3 | 0.030 | 0.76 | 0.015 |
| 18 | 3 | 0.040 | 1.02 | 0.019 |

³Average of the maximum and minimum values for two individual dried film products.

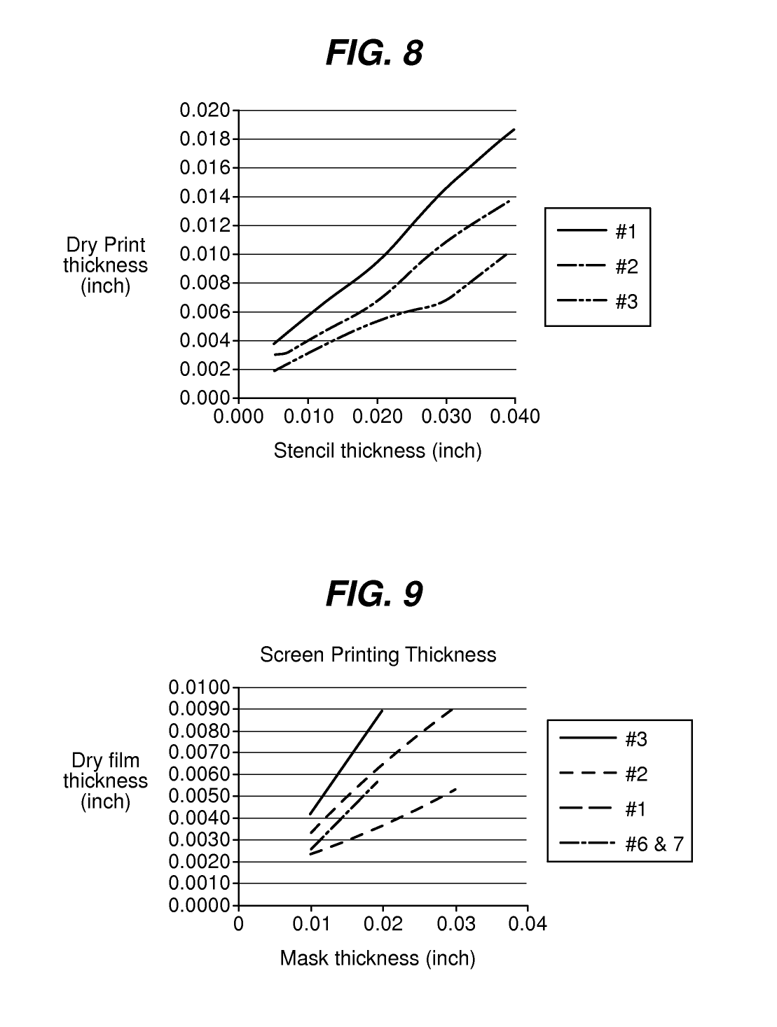

These results were plotted in a graph (FIG. 8) showing the linear relationship between the thickness of the stencil thickness and the solidified film product for Formulas 1-3.

### Examples 19-34

### Screen Printing

A rotary module screen printing apparatus (per FIG. 3) with a drum diameter of 5 inches was used. The outer surface of the drum was defined by a 0.003 inch nickel screen (40×40 mesh (openings/inch)) and a mask having the thickness identified in Table 3 (from 0.010 to 0.030 inches) was formed on the inner surface of the mesh. The film-forming compositions were deposed on a substrate as in Examples 1-30 (poly coated paper ULINE®). The results are shown in Table 3.

TABLE 3

| | | Mask | Mask | Avg. Dry | |
|---|---|---|---|---|---|
| | | Thick- | Thick- | Thick- | |
| Example | | ness | ness | ness⁴ | |
| # | Formula | (inch) | (mm) | (in) | Observations |
| 19 | 1 | 0.01 | 0.25 | 0.0023 | Some formula sticks |
| | | | | | to screen; bubbles in |
| | | | | | printed pattern |
| | | | | | dissipate over 2-3 |
| | | | | | minutes |
| 20 | 1 | 0.01 | 0.25 | 0.0020 | |
| 21 | 2 | 0.01 | 0.25 | 0.0034 | |
| 22 | 2 | 0.01 | 0.25 | 0.0030 | Some formula sticks |
| | | | | | to screen (less than |
| | | | | | Ex. 31); smaller |
| | | | | | bubbles than Ex. |
| | | | | | 31. |
| 23 | 3 | 0.01 | 0.25 | 0.0042 | Transferred from |
| | | | | | screen well; rough |
| | | | | | edges; most bubbles |
| | | | | | disappear during |
| | | | | | drying |
| 24 | 3 | 0.02 | 0.51 | 0.0090 | Required 2 squeegee |
| | | | | | wipes to fill and |
| | | | | | transfer; not all |
| | | | | | patterns transferred |
| | | | | | from screen |
| 25 | 4 | 0.02 | 0.51 | 0.0044 | Very thin; |
| | | | | | formulation runs; |
| | | | | | wide variations in |
| | | | | | finished product |
| | | | | | thickness |
| 26 | 5 | 0.02 | 0.51 | 0.0158 | Formulation is |
| | | | | | sticky and stringy; |
| | | | | | only partial release |
| | | | | | from screen |
| 27 | 1 | 0.02 | 0.51 | 0.0036 | Numerous bubbles |
| | | | | | that disappear |
| | | | | | within 3 minutes. |
| 28 | 2 | 0.02 | 0.51 | 0.0065 | Required 2 squeegee |
| | | | | | wipes to fill and |
| | | | | | transfer; not all |
| | | | | | patterns transferred |
| | | | | | from screen |
| 29 | 6 | 0.02 | 0.51 | 0.0059 | Numerous bubbles |
| 30 | 7 | 0.02 | 0.51 | 0.0058 | No bubbles, but |
| | | | | | ribbing effect; |
| | | | | | texture remains |
| | | | | | upon drying |
| 31 | 6 | 0.01 | 0.25 | 0.0025 | Numerous bubbles |
| 32 | 7 | 0.01 | 0.25 | 0.0025 | No bubbles, but |
| | | | | | ribbing effect; |
| | | | | | texture remains |
| | | | | | upon drying |
| 33 | 1 | 0.03 | 0.76 | 0.0053 | Very thin; |
| | | | | | formulation runs |
| | | | | | and sticks to screen |
| 34 | 2 | 0.03 | 0.76 | 0.0091 | Requires multiple |
| | | | | | squeegee passes to |
| | | | | | fill and transfer |
| | | | | | formulation |

⁴Average of the maximum and minimum values for six two individual dried films products.

These results were plotted in a graph (FIG. 9) showing the linear relationship between the thickness of the stencil thickness and the integral film product. The data includes Formulas 1-3, separately, and Formulas 6 and 7 combined, as the % solids was believed to be substantially the same and the resulting dry film thickness was substantially the same for a given mask thickness.

The specification and embodiments above are presented to aid in the complete and non-limiting understanding of the invention disclosed herein. Since many variations and embodiments of the invention can be made without departing from its spirit and scope, the invention resides in the claims hereinafter appended.

1. A process for forming an integral film product comprising the steps of:
a. placing a mask having at least one aperture having a shape corresponding to the desired integral film product over a substrate having a releasable surface;
b. delivering a film-forming composition through the at least one aperture of the mask to form a raw shape corresponding to the at least one aperture on the substrate;
c. removing the mask;
d. transforming the raw shape into the integral film product disposed on the substrate; wherein the integral film product is arranged and configured to be removable from the releasable surface of the substrate for use independent of the substrate.

2. The process of claim 1, wherein the mask is arranged on a cylindrical surface of a rotary drum having an interior, and the at least one aperture is in fluid communication with the interior of the rotary drum.

3. The process of claim 1, wherein the mask has a screen disposed across the at least one aperture.

4. The process of claim 3, wherein a squeegee having a blade angle between about 20° and about 40° the film-forming composition through the screen.

5. The process of claim 4, wherein a nozzle delivers the film-forming composition under pressure to the mask.

6. The process of claim 1, wherein the mask is a stencil.

7. The process of claim 6, wherein a nozzle delivers the film-forming composition under pressure to the mask.

8. The process of claim 1, wherein the raw shape has a thickness of at least about 0.5 mm.

9. A process for forming an integral film product comprising the steps of:
a. placing a mask having at least one aperture having a design corresponding to the desired integral film product over a substrate having a releasable surface;
b. delivering a film-forming composition comprising a benefit agent through the at least one aperture of the mask to form a raw shape corresponding to the at least one aperture on the substrate;
c. removing the mask;
d. transforming the raw shape into the integral film product disposed on the substrate, wherein the integral film product has a first surface arranged and configured to be removable from the releasable surface of the substrate for use independent of the substrate and wherein the benefit agent is deliverable through the first surface of the integral film product.

10. An integral film product comprising made according to the process of claim 1.

11. An integral film product comprising made according to the process of claim 9.
